(19) United States
(12) Patent Application Publication
(10) Pub. No.: US 2012/0247810 A1
(43) Pub. Date: Oct. 4, 2012

(54) WIRING STRUCTURE OF ELECTRICAL APPARATUS, AND IMAGE FORMING APPARATUS

(76) Inventor: Daisuke SHIGE, Osaka (JP)

(21) Appl. No.: 13/438,623

(22) Filed: Apr. 3, 2012

(30) Foreign Application Priority Data
Apr. 4, 2011 (JP) 2011-082965

(51) Int. Cl. H01B 7/24

(52) U.S. Cl. 174/136

(57) ABSTRACT

An image forming apparatus includes a protective member which is mounted to an opening of a rear panel and is formed as a resin tabular body in which a cover portion, an edge portion, and a plurality of holding portions are integrally formed. The protective member is fixed to the rear panel at the edge portion. The cover portion has a shape smaller than the opening. The edge portion has an external shape which is larger than the opening, and the edge portion being positioned outside the cover portion to provide a gap therebetween. The plurality of holding portions are independently Positioned in the gap and each of the holding portions connects the edge portion and the cover portion.

### CROSS REFERENCE

This Nonprovisional application claims priority under 35 U.S.C. §119(a) on Patent Application No. 2011-082965 filed in Japan on Apr. 4, 2011 the entire contents of which are hereby incorporated by reference.

### BACKGROUND OF THE INVENTION

The present invention relates to a wiring structure when an external electrical apparatus is mounted to an electrical apparatus, such as an image forming apparatus and also relates to an image forming apparatus provided with such a wiring structure.

A unitized external electrical apparatus, such as a peripheral device and optional equipment, may be selectively mounted externally to a main body of an electric apparatus, such as an image forming apparatus. When power is directly supplied to the external electrical apparatus, wiring becomes complicated around the main body of the electric apparatus. As a solution to the problem, some apparatuses are configured to supply power from the main body of the electric apparatus to the external electrical apparatus externally mounted to the main body of the electric apparatus.

A harness for supplying power to the external electrical apparatus is connected to the external electrical apparatus, after passing through an opening formed in a support member of the main body of the electric apparatus and exposing from a rear side and the like to the outside. Since the support member is formed from a sheet metal in many cases, damage of the harness due to contact with an edge portion of the opening of the support member may cause a case where power cannot be supplied to the external electrical apparatus and may raise a possibility of causing an accident due to electric leak.

As disclosed in Japanese Patent Laid-Open Publication No. 2005-032954 and Japanese Patent Laid-Open Publication No. 2010-256697, some wiring structures of conventional electrical apparatuses include a protective member which is formed of a thin resin material or an elastic film and is disposed at the opening of the support member. A holding portion formed on the protective member holds the harness, and prevents the harness from contacting with the edge portion of the opening.

However, with the configuration described in Japanese Patent Laid-Open Publication No. 2005-032954, breakage of components is easily caused since straight cut lines are formed in a superposed state on a harness clamp as a protective member. Moreover, in wiring work using the harness clamp, the harness is passed through an insertion port of the harness clamp and the opening of the support member and is connected with an external electrical apparatus, and thereafter the harness clamp is fixed to the support member. For this reason, the harness cannot be protected from the edge portion of the opening until the harness clamp is fixed to the support member. Furthermore, it is necessary to remove the harness clamp from the support member at a time of replacement of the harness.

In addition, with the configuration described in Japanese Patent Laid-Open Publication No. 2010-256697, the elastic film as a protective member has a high possibility of generating deformation and breakage due to a change with passage of time, and has a problem that the film easily comes off from the support member at the time of replacement of the harness.

In view of the foregoing problems, it is an object of the present invention to provide a wiring structure of an electrical apparatus capable of easily mounting a protective member to a support member and easily performing connection work of a harness over a long period of time, and to also provide an image forming apparatus including such a wiring structure.

### SUMMARY OF THE INVENTION

A wiring structure of an electrical apparatus of the present invention is a protective member which is mounted at an opening of a support member of a main body of the electric apparatus through which a harness passes, the protective member being a resin tabular body in which a cover portion, an edge portion, and a holding portion are integrally formed. The protective member is fixed to the support member at the edge portion. The cover portion has a shape smaller than the opening. The edge portion has an external shape which is larger than the opening, the edge portion being positioned outside the cover portion so as to provide a spacing therebetween. The holding portion is positioned at the spacing and connects the edge portion and the cover portion.

The foregoing and other features and attendant advantages of the present invention will become more apparent from the reading of the following detailed description of the invention in conjunction with the accompanying drawings.

### BRIEF DESCRIPTION OF THE DRAWINGS

FIG. 1 is an outline view showing a rear side of an image forming apparatus according to an embodiment of the present invention;

FIG. 2 is an outline view showing a rear side of the image forming apparatus in a state where an external electrical apparatus is externally mounted;

FIG. 3A is a plan view of a protective member according to the embodiment of the present invention;

FIG. 3B is a front elevational view of the protective member according to the embodiment of the present invention;

FIG. 3C is a bottom view of the protective member according to the embodiment of the present invention;

FIG. 3D is a side elevational view of the protective member according to an embodiment of the present invention;

FIG. 3E is a side sectional view of the protective member according to an embodiment of the present invention;

FIG. 4 is a front elevational view of the protective member from which a cover portion and a holding portion are removed.

### DETAILED DESCRIPTION OF THE INVENTION

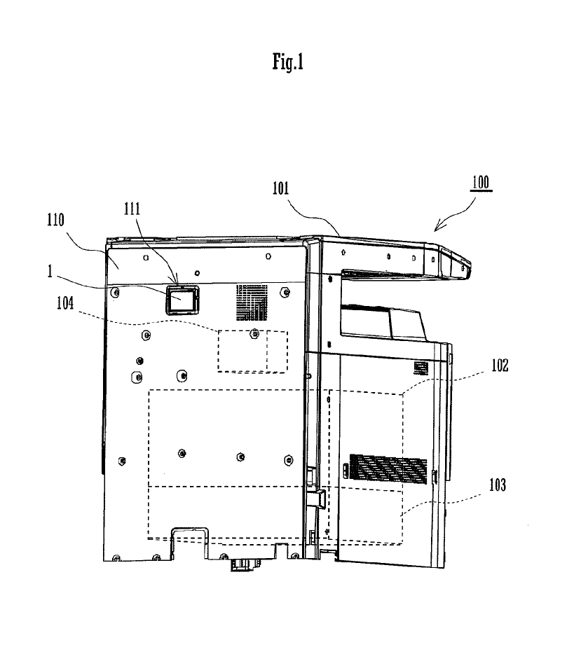

As shown in FIG. 1, an image forming apparatus 100 according to an embodiment of the present invention includes an image reading portion 101, an image forming portion 102, a paper feeding portion 103, and a power supply portion 104. The image reading portion 101 reads an image carried on a document. The paper feeding portion 103 feeds a sheet to the image forming Portion 102. The image forming portion 102 performs image formation on a sheet. The power supply portion 104 supplies power to the image reading portion 101, the image forming portion 102, and the paper feeding portion 103.

The image forming apparatus 100 includes a rear panel 110 with an opening 111. The rear panel 110 is a support member of the present invention, and is formed by processing a metal plate material by press working to a predetermined shape. A protective member 1 of the present invention is mounted to the opening 111. The protective member 1 covers the opening 111 and prevents dust from entering the inside of the image forming apparatus 100.

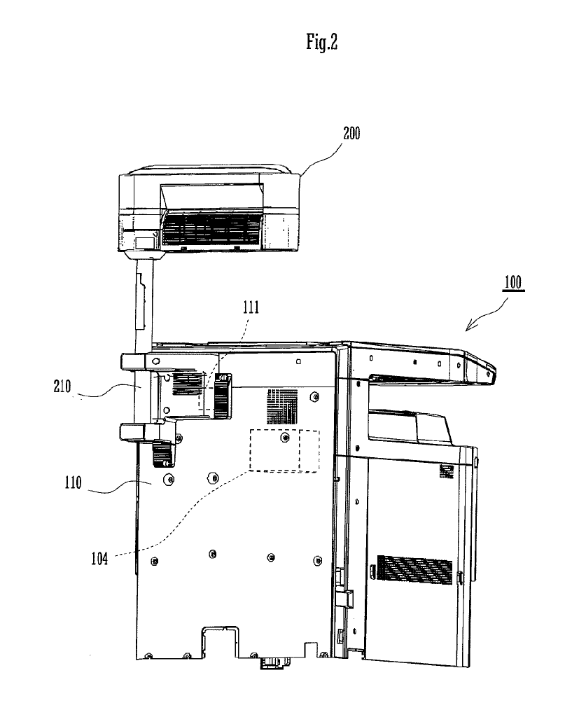

As shown in FIG. 2, an air cleaning device 200 as an external electrical apparatus of the present invention is selectively mounted externally to the image forming apparatus 100. The air cleaning device 200 has a mounting portion 210 screwed to the rear panel 110, and receives supply of power from the power supply portion 104 in the image forming apparatus 100 through a not illustrated harness. An opening 111 is formed in a position on which the mounting portion 210 is mounted on the rear panel 110. For this reason, the opening 111 is covered with the mounting portion 210 when the air cleaning device 200 is externally mounted to the image forming apparatus 100.

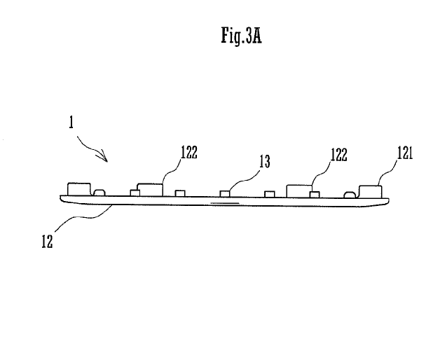

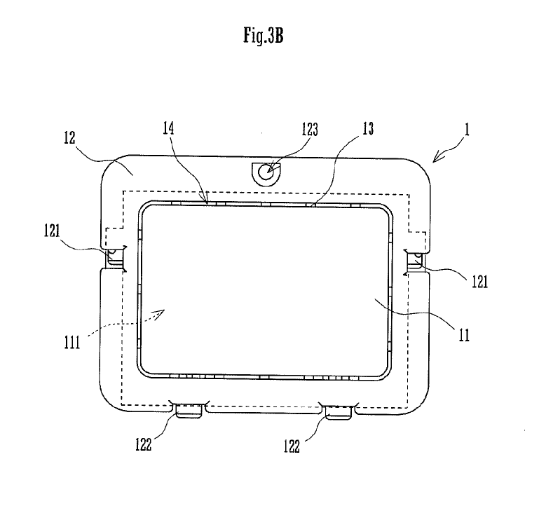

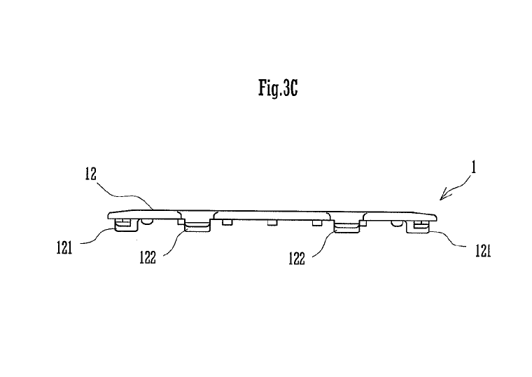

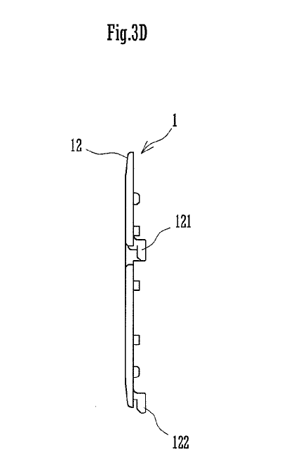

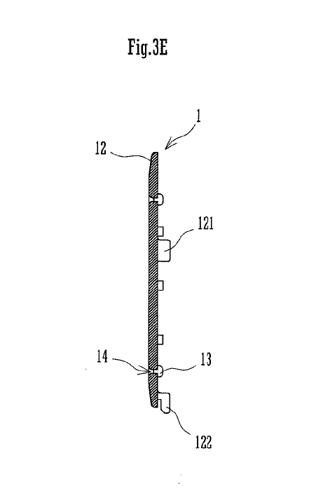

As shown in FIG. 3, the protective member 1 according to an embodiment of the present invention is a resin tabular plate which is integrally formed of a cover portion 11, an edge portion 12, and a plurality of holding portions 13. Between the cover portion 11 and the edge portion 12, a gap 14 is formed over the entire circumference. The gap 14 is equivalent to a spacing of the present invention. The plurality of holding portions 13 are arranged in the gap 14, and connect the cover portion 11 and the edge portion 12. Thus, the cover portion 11 is arranged inside the edge portion 12.

The external shape of the cover portion 11 is smaller than the opening 111. The external shape of the edge portion 12 is larger than the opening 111. The edge portion 12 includes locking portions 121 at right and left sides, respectively and locking portions 122 at two places at a lower side, respectively. All the locking portions 121,122 project toward the rear side, and open downward. The edge portion 12 includes a mounting hole 123 at an upper side. Each of the plurality of holding portions 13 has a small cross sectional area in the horizontal direction, and can be easily cut with a tool, such as a cutter. It is to be noted that a spacing is provided outside the cover portion 11 to arrange the edge portion 12, so that thin holding portions 13 may also be arranged over the whole area of the spacing.

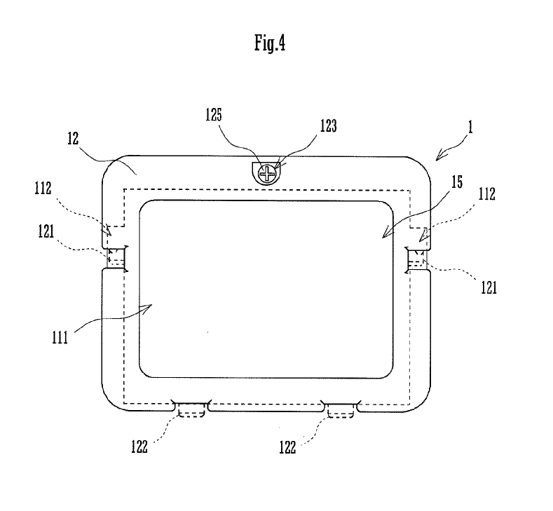

As shown in FIG. 4, the protective member 1 makes the locking portions 121, 122 lock at a peripheral edge part of the opening 111 to be mounted to the rear panel 110 by moving the locking portions 121 of the edge portion 12 to a lower part after making the locking portions 121 of the edge portion 12 insert into a recess 112 of the opening 111 from the outside to the inside. Thereafter, the protective member 1 can be easily fixed to the rear panel 110 by screwing a screw 125 inserted into a hole portion 123 into a screw hole formed on the rear panel 110.

In a case where the air cleaning device 200 is externally mounted to the image forming apparatus 100, the holding portions 13 are cut off from the edge portion 12 and the cover portion 11 is removed together with the holding portions 13. A through hole 15 is formed inside the edge portion 12 and can make a cable pass therethrough, the cable supplying power to the air cleaning device 200 from the power supply portion 104 of the image forming apparatus 100.

As shown in FIG. 3, at least the outside of an inner peripheral part of the edge portion 12 is rounded, so that the cable does not contact the edge portion of the opening 111 of the rear panel 11C which is formed from a sheet metal even though the cable may contact the edge portion 12 made of a resin. For this reason, even though passing-through work of the cable to the through hole 15 is repeated when the image forming apparatus 100 is moved and inspected, and the cable is exchanged, no damage is caused by contact of the cable and the edge portion of the opening 111.

It is to be noted that an external electrical apparatus which is externally mounted to the image forming apparatus 100 is not limited to the air cleaning device 200, but may be applied to other devices which receive supply of power from the power supply portion 104 of the image forming apparatus 100, such as a display. In addition, a cable is not only limited to a cable which supplies power but may also be a cable which includes a signal line.

The above described embodiments are to be considered in all respects as illustrative and not restrictive. The scope of the present invention is defined not by above described embodiments but by the claims. Further, the scope of the present invention is intended to include all modifications that come within the meaning and scope of the claims and any equivalents thereof.

What is claimed is:

1. A wiring structure of an electrical apparatus, comprising:
a protective member which is mounted at an opening formed on a support member of a main body of the electrical apparatus through which a harness can pass, the protective member comprising: a cover portion; an edge portion; and a holding portion, the protective member being fixed to the support member at the edge portion, the cover portion having an external shape which is smaller than the opening, the edge portion having an external shape which is larger than the opening, the edge portion being positioned at a periphery of the cover portion with a spacing between the edge portion and the cover portion, and the holding portion being positioned at the spacing and connects the cover portion and the edge portion.

2. The wiring structure of an electrical apparatus according to claim 1, wherein the protective member is a resin tabular body in which the cover portion, the edge portion, and the holding portion are integrally formed.

3. The wiring structure of an electrical apparatus according to claim 1, wherein the edge portion includes: a plurality of locking portions each of which opens downward; and at least one mounting hole into which a screw screwed into the support member is inserted.

4. The wiring structure of an electrical apparatus according to claim 2, wherein the edge portion includes: a plurality of locking portions each of which opens downward; and at least one mounting hole into which a screw screwed into the support member is inserted.

5. An image forming apparatus as the main body of an electrical apparatus, comprising the wiring structure of an electrical apparatus according to claim 1, wherein the opening is formed in a position where an external electrical apparatus in the support member is selectively mounted.

6. An image forming apparatus as the main body of an electrical apparatus, comprising the wiring structure of an electrical apparatus according to claim 2, wherein the opening is formed in a position where an external electrical apparatus in the support member is selectively mounted.

7. An image forming apparatus as the main body of an electrical apparatus, comprising the wiring structure of an electrical apparatus according to claim 3, wherein the opening is formed in a position where an external electrical apparatus in the support member is selectively mounted.
